(19) United States
(12) Patent Application Publication
(10) Pub. No.: US 2018/0276913 A1
(43) Pub. Date: Sep. 27, 2018

(54) REMOTE VEHICLE NETWORK MONITORING AND FAILURE PREDICTION SYSTEM

(71) Applicant: Faraday&Future Inc., Gardena, CA (US)

(72) Inventors: Mario R. Garcia, Long Beach, CA (US); Omourtag Alexandrov Velev, La Crescenta, CA (US); Dong Ryeol Lee, San Jose, CA (US)

(21) Appl. No.: 15/721,154

(22) Filed: Sep. 29, 2017

Related U.S. Application Data
(60) Provisional application No. 62/402,222, filed on Sep. 30, 2016.

(51) Int. Cl. G07C 5/08; G07C 5/00; B60L 3/12; H04L 12/40

(52) U.S. Cl. CPC G07C 5/0808; G07C 5/008; B60R 16/023; H04L 12/40; B60L 3/12

(57) ABSTRACT

Certain embodiments are described that provide a method for remotely monitoring vehicle electronic networks and predicting failures. Electronic module status data is received, remotely from a vehicle, from a plurality of modules on a vehicle electronic network in the vehicle. The status data for a plurality of vehicles is collected. The status data includes information indicative of potential future failure. The status data is correlated from the plurality of modules in the vehicle, for each of the plurality of vehicles, to provide correlated status data for each vehicle. The correlated status data is analyzed for the plurality of vehicles to identify a probable location of a potential failure in the at least one vehicle electronic network.

### CROSS-REFERENCE TO RELATED APPLICATIONS

This application claims the benefit of U.S. Provisional Application No. 62/402,222, filed Sep. 30, 2016, the entirety of which is hereby incorporated by reference.

### BACKGROUND

Aspects of the disclosure relate to remote monitoring and diagnostics for electric vehicles in use.

Sensors in vehicles can monitor particular components for failure. Information from the sensors can be transmitted wirelessly to a remote monitoring system for evaluation. As electric and self-driving vehicles become more complex, a more robust method of monitoring all aspects of a vehicles electronic system is needed.

### SUMMARY

Certain embodiments are described that provide a method for remotely monitoring vehicle electronic networks and predicting failures. Electronic module status data is received, remotely from a vehicle, from a plurality of modules on a vehicle electronic network in the vehicle. The status data for a plurality of vehicles is collected. The status data includes information indicative of potential future failure. The status data is correlated from the plurality of modules in the vehicle, for each of the plurality of vehicles, to provide correlated status data for each vehicle. The correlated status data is analyzed for the plurality of vehicles to identify the probable location of a potential failure in the at least one vehicle electronic network.

In one embodiment the probable location of potential failure is at least one of a particular module, a group of modules, a connection between modules, a particular controller area network or an Ethernet bus. An estimated life expectancy is determined for each of the plurality of modules based on analysis of the error information. In one embodiment, the module is a battery element, and the remaining capacity of the battery element is determined.

### BRIEF DESCRIPTION OF THE DRAWINGS

Aspects of the disclosure are illustrated by way of example. In the accompanying figures, like reference numbers indicate similar elements.

FIG. 1 shows an embodiment of a physical map for a high-voltage system and batteries in an electric vehicle;

FIG. 2 is a diagram illustrating an electronic network in an electric vehicle according to an embodiment;

FIG. 3 shows an embodiment of a flow chart illustrating a data analysis system for an electric vehicle;

FIG. 4 illustrates an example of a computing system in which one or more embodiments may be implemented.

### DETAILED DESCRIPTION

Examples are described herein in the context of generating data relating to performance and failures in a vehicle. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

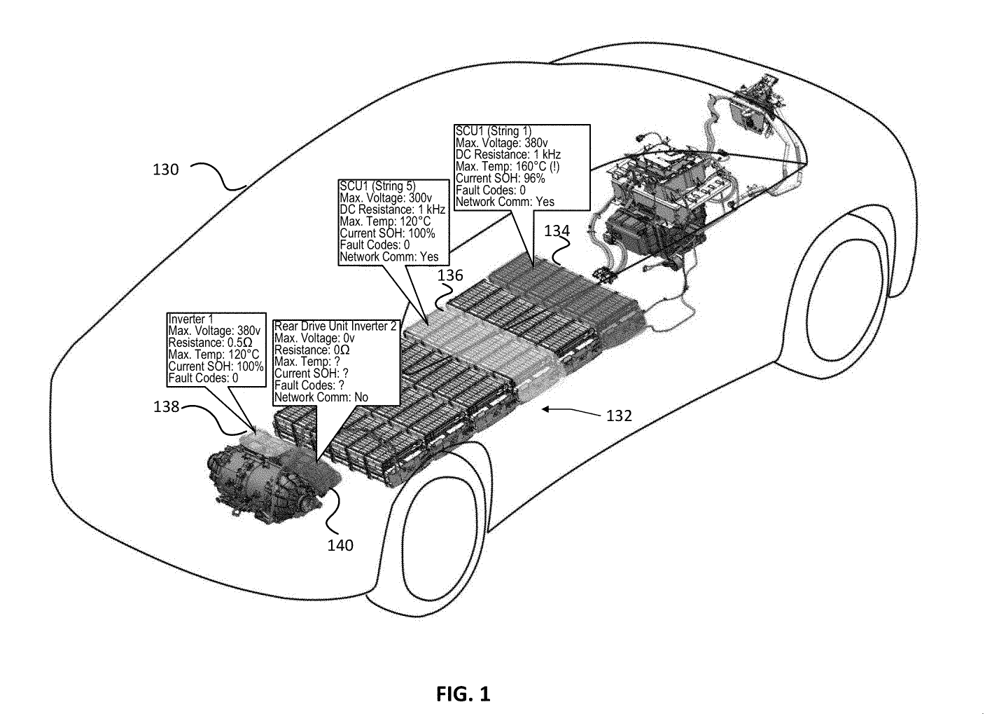

FIG. 1 shows an embodiment of a physical map for a high-voltage system and batteries in an electric vehicle. A vehicle 130 is shown. The vehicle has a battery pack 132 which is modularized with different battery strings, such as battery strings 134 and 136. A battery string, in turn, is composed of battery modules, and the modules are composed of hundreds of individual battery cells. Sensors are attached to the battery strings, as well as individual modules and even individual cells. The sensors can include thermocouples for monitoring the heat of a cell, module or string, and sensors for monitoring the voltage and current into and out of the various battery components. An example of characteristics of the data provided for a battery string 134 is the following:

SCUI (String 1)

Max Voltage: 380 v

DC Resistance: 1 kHz

Max Temp.: 160° C.

Current SOH −96%

Fault Codes: 0

Network Comm.: Yes

Data is also shown in FIG. 1 for inverters 138 and 140. An example of characteristics of the data provided for inverter 138, including electronic module status data reported by the vehicle, is the following:

Inverter 1

Max. Voltage: 380 v

Resistance: 0.50

Max. Temp.: 120° C.

Current SOH: 100%

Fault Codes: 0

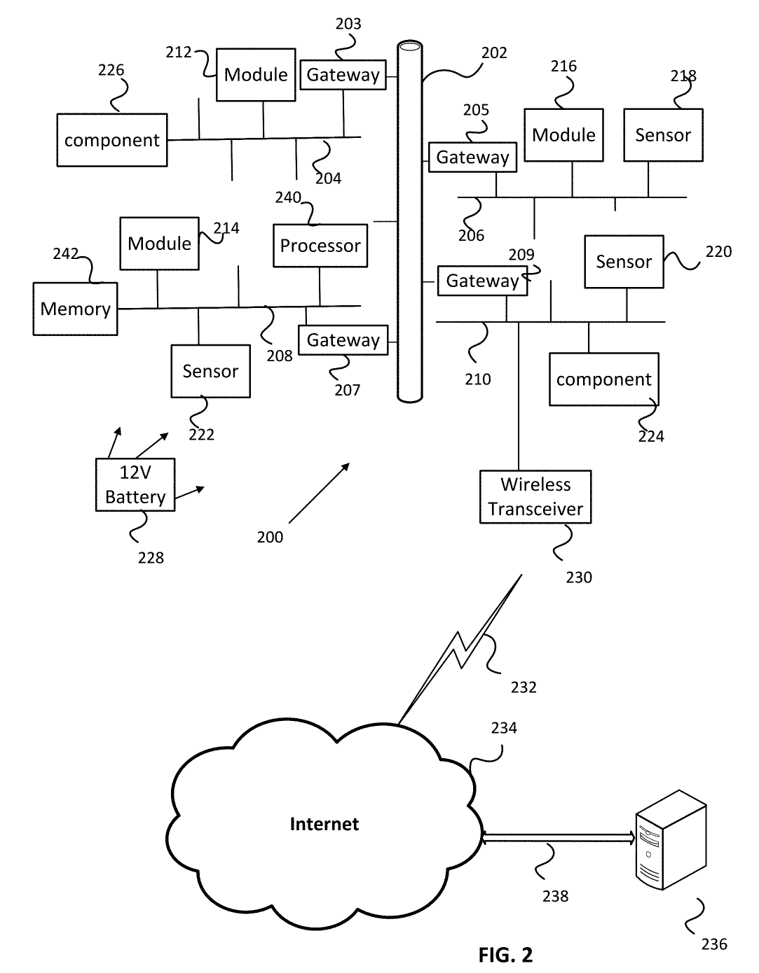

FIG. 2 is a diagram illustrating an electronic network 200 in an electric vehicle according to an embodiment. An Ethernet backplane bus 202 interconnects multiple Controller Area Networks (CANs), such as CANs 204, 206, 208 and 210, through respective gateways 203, 205, 207 and 209. In one embodiment, 9 CANs are provided, although any number may be used. The CANs connect to various modules, such as modules 212, 214 and 216. The CANs also connect to various sensors, such as sensors 218, 220 and 222. Also, other components such as components 224 and 226 are connected to the CANs. Power is provided by a 12V battery 228 that is separate from the drive battery rack of FIG. 1.

The system connects to various sensors, modules and other components. The State of Health (SOH) of the sensors, modules and other components is monitored, along with the status of the connections to the network. One example of certain components of the electronic module status data provided for sensor 102 is the following:

Ultrasonic Parking Sensor 1

Max. Voltage: 16.2 v

Resistance: 0.20

Max. Temp: 29° C.

Current SOH: 100%

Network Comm: Yes

The system has a multitude of other sensors, modules and other components. Failures can occur in any sensor, module or component, as well as in the interconnections and busses.

Status data is sent to a wireless transceiver 230, which communicates via a wireless communication link 232 to the Internet 234. A remote server 236 receives the status data over its connection 238 to the Internet. The status data can be sent directly from the individual modules and sensors to the transceiver 230, or to a processor 240 with associated memory 242. Processor 240 can do some pre-processing of the data before sending it to transceiver 230 for transmission to remote server 236.

In one embodiment, remote server 236 is one of multiple servers in different data centers at different geographical locations. The servers analyze and act upon vehicle data flowing to the data centers. A comprehensive system analyzes vehicle data logs from a plurality of vehicles. The group data is used to create prognostic/predictive models to determine the vehicle State of Health (SOH), at pre-determined points in time, and set thresholds to either apply upgrade firmware (preventive reflash) or replace the module prior to total failure.

### Vehicle System Snapshot:

A snapshot of vehicle systems is taken at various points after manufacturing. The vehicle SOH Report collects module, or major component, data and assigns a value (in percentage) to correspond with the current condition of the component and calculate life expectancy for the component.

After determining a life expectancy value, a recommendation is made to either deploy countermeasures (upgrade firmware) or schedule a service center visit for the customer.

In addition to determining SOH, the system incorporates a machine learning tool that recommends an appropriate course of action (repair procedure) for the technician, based on historical component failure data.

A cloud base analysis system is used to collect at regular intervals (daily/weekly/monthly) SOH Reports. These reports are used to build a predictive model that is based on data from other vehicles with similar history and/or usage.

One example is a full feature tracking of each battery cell. Data from the SOH Report provides users with granular detail on the full usage life of each battery cell and provide the ability to better root cause battery cell failures and predict future failures.

In one embodiment, modules are configured to produce periodic status data, and to pass on status data received from sensors and other components. A module may include a processor and memory, or a separate processor and memory module may be used to collect data. In addition to module, sensor and component status, data packets are monitored over the various buses to detect data corruption, faults or other anomalies. A particular fault code can be assigned, and the information can be sent to the remote server through wireless transceiver 230. Alternately, a wired upload of status data can be done periodically, such as when the vehicle is at a charging station.

The reports from various elements of the system are used to identify actual or potential failures. For example, if two modules are communicating over a common line, and both are reporting faults related to that line, that suggests a possible short in the line or connector to one of the two modules. If the status of both modules is otherwise fault-free, this would indicate it is the connection, not the modules, which need replacing. The modules will report the voltage on every pin, for example. Faulty performance can be due to short circuits, corrosion, or a variety of other causes.

By collecting data from an entire group of vehicles, usage patterns of vehicles can be correlated to predict failure patterns or possible upgrades. Statistical life expectancy of vehicle components and connections can be estimated from the usage data collected. The life expectancy may vary by region and usage. For example, vehicles in harsh weather environments where the driver often does rapid acceleration and hard braking may have components wear out faster than other vehicles. The weather conditions can be detected by both vehicle sensors and the GPS location of the vehicle, which can be correlated with weather reports.

The data can be calibrated using information about actual time to failure from manufacturer warranty information and repair shop information.

The vehicle battery sensor data is analyzed for the group of vehicles, with similar correlation for geography and usage patterns. Performance can be analyzed taking into account not only usage patterns and geography, but also battery status details such as age and history. The analysis can determine when the battery is expected to fail. This analysis can be done at the pack, string, module, individual cell, and connections levels. Various parameters of the battery elements are monitored, including voltage, impedance, DC resistance and temperature. A high temperature, for example, will typically reduce the expected lifetime of the battery element. High voltages can lead to high temperatures, with corresponding problems. A high temperature may indicate various problems, such as a fault in the cooling system.

In one embodiment, based on the usage data, preventive maintenance can be recommended that pinpoints potential areas of failure. Failing sensors can be instructed to shut down, with the function being taken over by redundant sensors until the vehicle can be repaired. In addition, where the data is not determinative, diagnostic tests can be recommended to pinpoint the potential or actual problem points when the vehicle is brought in for service. Alternately, the diagnostics could be run when the vehicle is parked and charging.

In one embodiment, the group data is filtered based on various parameters such as geography and usage data. Pattern recognition is applied with different combinations of filters being used until patterns emerge. Artificial intelligence, or machine learning, allows large amounts of group data to be correlated to the data from a particular vehicle to enhance or confirm the diagnostics.

In one embodiment, a Graphical User Interface (GUI) provides an overall State of Health (SOH) of the vehicle, with drill down provided for subsystems and elements of each subsystem. The overall SOH is a weighted average of the SOH of the subsystems. The weighting is done by criticality to vehicle performance. Similarly, the subsystems have a weighted SOH. For example, a failing proximity sensor for parking is given a low weight if there are redundant proximity sensors that are functioning properly. Also, the parking subsystem may be given a lower weight since the driver can take over after being given a proximity sensor failure notice. For failure of other systems, such as braking, the failure is more critical. A notice to the driver after the fact that the brakes have failed is not very useful.

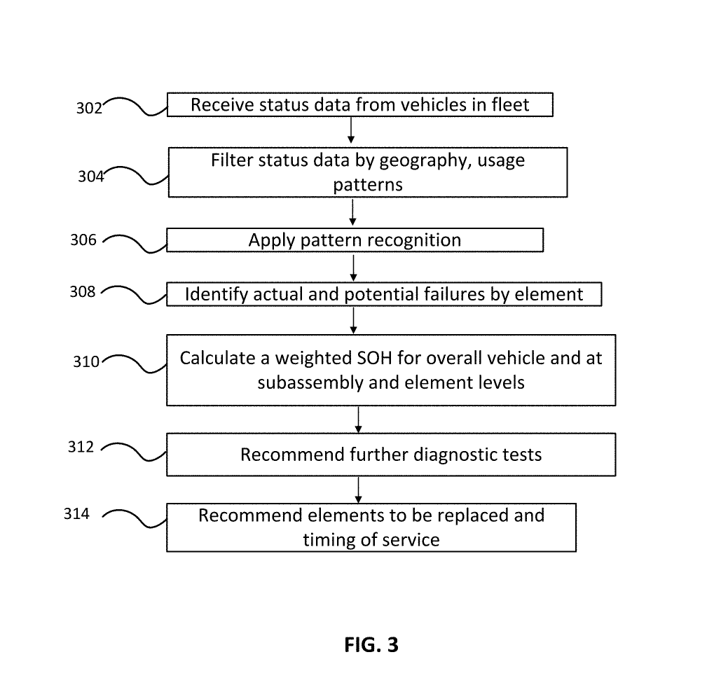

FIG. 3 shows an embodiment of a flow chart illustrating a data analysis system for an electric vehicle. Status data on modules, sensors, other components, connections, buses and other elements of the vehicle network are received (302). The data from the group of vehicles is stored in a database, and is filtered by geography and usage patterns (304). Pattern recognition is used to both identify usage patterns and identify fault and failure patterns (306). Actual and potential failure points are identified (308). A weighted SOH is calculated for the vehicle and each of the sub-assemblies and for each element that is monitored (310). Where a fault cannot be precisely pinpointed, further diagnostic tests are recommended (312). Elements to be replaced are recommended (314). Replacement can be for parts that have failed, or where failure is predicted in the future. The timing of a service visit is recommended based on the timing of the actual or future likely fault or failure.

### Computer System

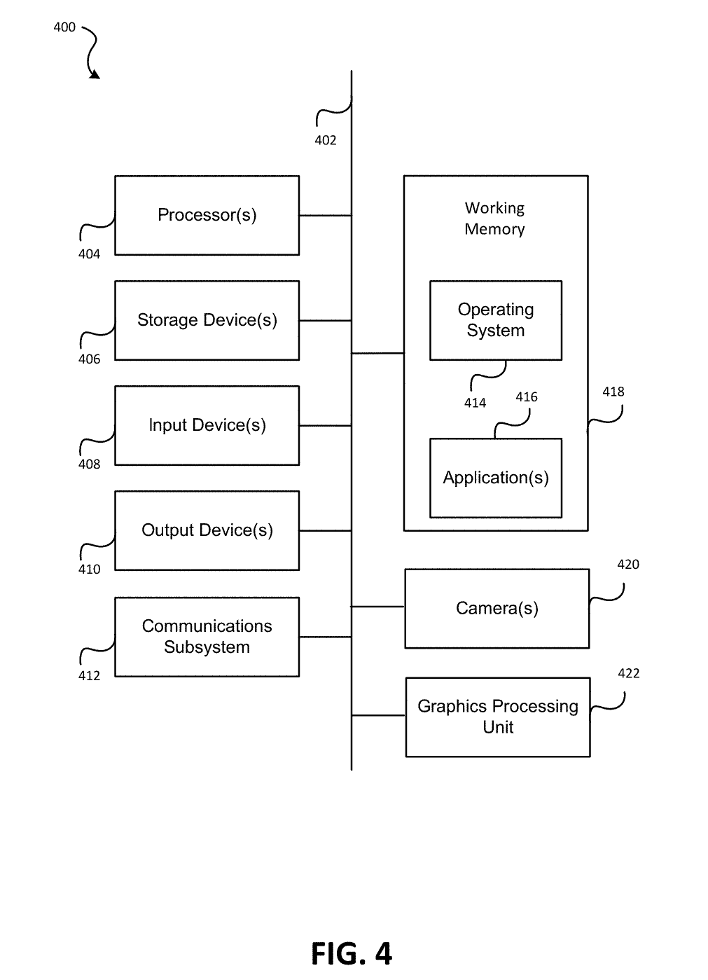

FIG. 4 illustrates an example of a computing system in which one or more implementations may be implemented. A computer system as illustrated in FIG. 4 may be incorporated as part of the above described Server 236 or processor 240 (or another computer mounted in the vehicle). For example, computer system 400 can represent some of the components of a display, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other handheld devices. FIG. 4 provides a schematic illustration of one implementation of a computer system 400 that can perform the methods provided by various other implementations, as described herein, and/or can function as the host computer system, a remote kiosk/terminal, a telephonic or navigation or multimedia interface in an automobile, a computing device, a set-top box, a table computer and/or a computer system. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 402 (or may otherwise be in communication, as appropriate). The hardware elements may include one or more processors 404, including without limitation one or more general-purpose processors and/or one or more special-purpose processors (such as digital signal processing chips, graphics processing units 422, and/or the like); one or more input devices 408, which can include without limitation one or more cameras, sensors, a mouse, a keyboard, a microphone configured to detect ultrasound or other sounds, and/or the like; and one or more output devices 410, which can include without limitation a display unit such as the device used in implementations of the invention, a printer and/or the like. Additional cameras 420 may be employed for detection of user's extremities and gestures. In some implementations, input devices 408 may include one or more sensors such as infrared, depth, and/or ultrasound sensors. The graphics processing unit 422 may be used to carry out the method for real-time wiping and replacement of objects described above.

In some implementations of the implementations of the invention, various input devices 408 and output devices 410 may be embedded into interfaces such as display devices, tables, floors, walls, and window screens. Furthermore, input devices 408 and output devices 410 coupled to the processors may form multi-dimensional tracking systems.

The computer system 400 may further include (and/or be in communication with) one or more non-transitory storage devices 406, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 400 might also include a communications subsystem 412, which can include without limitation a modem, a network card (wireless or wired), an infrared communication device, a wireless communication device and/or chipset (such as a Bluetooth device, an 802.11 device, a Wi-Fi device, a WiMax device, cellular communication facilities, etc.), and/or the like. The communications subsystem 412 may permit data to be exchanged with a network, other computer systems, and/or any other devices described herein. In many implementations, the computer system 400 will further comprise a non-transitory working memory 418, which can include a RAM or ROM device, as described above.

The computer system 400 also can comprise software elements, shown as being currently located within the working memory 418, including an operating system 14, device drivers, executable libraries, and/or other code, such as one or more application programs 416, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 406 described above. In some cases, the storage medium might be incorporated within a computer system, such as computer system 400. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 400 may be omitted or may be implemented separate from the illustrated system. For example, the processor 404 and/or other elements may be implemented separate from the input device 408. In one implementation, the processor may be configured to receive images from one or more cameras that are separately implemented. In some implementations, elements in addition to those illustrated in FIG. 4 may be included in the computer system 400.

Some implementations may employ a computer system (such as the computer system 400) to perform methods in accordance with the disclosure. For example, some or all of the procedures of the described methods may be performed by the computer system 400 in response to processor 404 executing one or more sequences of one or more instructions (which might be incorporated into the operating system 414 and/or other code, such as an application program 416) contained in the working memory 418. Such instructions may be read into the working memory 418 from another computer-readable medium, such as one or more of the storage device(s) 406. Merely by way of example, execution of the sequences of instructions contained in the working memory 418 might cause the processor(s) 404 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 400, various computer-readable media might be involved in providing instructions/code to processor(s) 404 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 406. Volatile media include, without limitation, dynamic memory, such as the working memory 418. Transmission media include, without limitation, coaxial cables, copper wire and fiber optics, including the wires that comprise the bus 402, as well as the various components of the communications subsystem 412 (and/or the media by which the communications subsystem 412 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 404 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various implementations of the invention.

The communications subsystem 412 (and/or components thereof) generally will receive the signals, and the bus 402 then might carry the signals (and/or the data, instructions, etc. carried by the signals) to the working memory 418, from which the processor(s) 404 retrieves and executes the instructions. The instructions received by the working memory 418 may optionally be stored on a non-transitory storage device 406 either before or after execution by the processor(s) 404.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method for remotely monitoring electronic networks in vehicles and predicting failures, comprising:
receiving, remotely from a vehicle, electronic module status data from a plurality of modules on at least one vehicle electronic network in the vehicle, wherein the status data includes information indicative of potential future failure;
repeating the receiving step for a plurality of vehicles;
correlating the status data from the plurality of modules in the vehicle, for each of the plurality of vehicles, to provide correlated status data for each vehicle; and
analyzing the correlated status data for the plurality of vehicles to identify a probable location of a potential failure in the at least one vehicle electronic network of one of the vehicles.

2. The method of claim 1 wherein the status data is received for multiple locations in a hierarchy of the at least one vehicle electronic network, the hierarchy including a plurality of a sensor, a module, a connection between modules, a particular controller area network or an Ethernet bus.

3. The method of claim 1 further comprising:
determining an estimated life expectancy for each of the plurality of modules based on analysis of the status data.

4. The method of claim 3 further comprising:
wherein the module is a battery element, determining a remaining capacity of the battery element.

5. The method of claim 3 further comprising:
providing a recommended corrective action based on the estimated life expectancy.

6. The method of claim 3 further comprising:
receiving supplier module failure data;
including the supplier module and component failure data in the determining an estimated life expectancy for each of the plurality of modules.

7. The method of claim 1 further comprising:
receiving sensor data from a plurality of sensors in the vehicle for each of the plurality of vehicles;
determining a subset of the plurality of vehicles with similar sensor data patterns; and
analyzing the correlated status data for the subset of the plurality of vehicles to identify the probable location of the potential failure in the at least one vehicle electronic network.

8. The method of claim 6 further comprising:
providing a recommended corrective action based on probable location.

9. The method of claim 1 wherein analyzing the correlated status data for the plurality of vehicles to identify the probable location of the potential failure in the at least one vehicle electronic network further comprises:
determining a probable location in a hierarchy of a battery system, the hierarchy including a pack, a string, a module and a cell.

10. The method of claim 1 wherein the status data includes packet corruption data for a controller area network.

11. A non-transitory computer readable media having computer readable code for remotely monitoring a vehicle electronic network and predicting failures, comprising computer readable instructions for:
receiving, remotely from a vehicle, electronic module status data from a plurality of modules on at least one vehicle electronic network in the vehicle, wherein the status data includes information indicative of potential future failure;
repeating the receiving step for a plurality of vehicles;
correlating the status data from the plurality of modules in the vehicle, for each of the plurality of vehicles, to provide correlated status data for each vehicle; and
analyzing the correlated status data for the plurality of vehicles to identify a probable location of a potential failure in the at least one vehicle electronic network of one of the vehicles.

12. The non-transitory computer readable media of claim 11 wherein the status data is received for multiple locations in a hierarchy of the at least one vehicle electronic network, the hierarchy including a plurality of a sensor, a module, a connection between modules, a particular controller area network or an Ethernet bus.

13. The non-transitory computer readable media of claim 11 further comprising:
determining an estimated life expectancy for each of the plurality of modules based on analysis of the status data.

14. The non-transitory computer readable media of claim 13 further comprising computer readable instructions for:
wherein the module is a battery element, determining a remaining capacity of the battery element.

15. The non-transitory computer readable media of claim 13 further comprising computer readable instructions for:
providing a recommended corrective action based on the estimated life expectancy.

16. The non-transitory computer readable media of claim 13 further comprising instructions for:
receiving supplier module failure data;
including the supplier module and component failure data in the determining an estimated life expectancy for each of the plurality of modules.

17. The non-transitory computer readable media of claim 11 further comprising computer readable instructions for:
receiving sensor data from a plurality of sensors in the vehicle for each of the plurality of vehicles;
determining a subset of the plurality of vehicles with similar sensor data patterns; and
analyzing the correlated status data for the subset of the plurality of vehicles to identify the probable location of the potential failure in the at least one vehicle electronic network.

18. The non-transitory computer readable media of claim 16 further comprising computer readable instructions for:
providing a recommended corrective action based on probable location.

19. The non-transitory computer readable media of claim 11 wherein analyzing the correlated status data for the plurality of vehicles to identify the probable location of the potential failure in the at least one vehicle electronic network further comprises:
determining a probable location in a hierarchy of a battery system, the hierarchy including a pack, a string, a module and a cell.

20. The non-transitory computer readable media of claim 1 wherein the status data includes packet corruption data for a controller area network.
